(19) United States
(12) Patent Application Publication
(10) Pub. No.: US 2013/0232456 A1
(43) Pub. Date: Sep. 5, 2013

(54) OPTICAL PROXIMITY CORRECTION METHODS FOR MASKS TO BE USED IN MULTIPLE PATTERNING PROCESSES

(71) Applicants: Chidambaram G. Kallingal, Poughkeepsie, NY (US); Norman S. Chen, Poughkeepsie, NY (US); Jian Liu, Beacon, NY (US)

(72) Inventors: Chidambaram G. Kallingal, Poughkeepsie, NY (US); Norman S. Chen, Poughkeepsie, NY (US); Jian Liu, Beacon, NY (US)

(73) Assignee: GLOBALFOUNDRIES INC., Grand Cayman (KY)

(21) Appl. No.: 13/410,729

(22) Filed: Mar. 2, 2012

(51) Int. Cl. G06F 17/50

(52) U.S. Cl. 716/53

(57) ABSTRACT

Disclosed herein are various OPC methods as it relates to the formation of masks to be used in multiple patterning processes, such as double patterning processes, and to the use of such masks during the manufacture of semiconductor devices. One illustrative method disclosed herein includes the steps of decomposing an initial overall target pattern into at least a first sub-target pattern and a second sub-target pattern, wherein each of the first and second sub-target patterns comprise at least one feature, and performing a first optical proximity correction process on the first sub-target pattern, wherein a position of at least one feature of the second sub-target pattern in the initial overall target pattern is considered when performing the first optical proximity correction process.

### BACKGROUND OF THE INVENTION

1. Field of the Invention

Generally, the present disclosure relates to the manufacturing of sophisticated semiconductor devices, and, more specifically, to various optical proximity correction (OPC) methods as it relates to the design of masks or reticles to be used in multiple patterning processes, such as double patterning processes, and the use of such masks or reticles in various photolithography systems to manufacture integrated circuit products.

2. Description of the Related Art

Photolithography is one of the basic processes used in manufacturing integrated circuit products. At a very high level, photolithography involves (1) forming a layer of light or radiation-sensitive material, such as photoresist, above a layer of material or a substrate, (2) selectively exposing the radiation-sensitive material to a light generated by a light source (such as a DUV or EUV source) to transfer a pattern defined by a mask or reticle (inter-changeable terms) to the radiation-sensitive material, and (3) developing the exposed layer of radiation-sensitive material to define a patterned mask layer. Various process operations, such as etching or ion implantation processes, may then be performed on the underlying layer of material or substrate through the patterned mask layer.

The design and manufacture of reticles used in such photolithography processes is a very complex and expensive undertaking as such masks must be very precise and must enable the repeated and accurate formation of a desired pattern in the underlying layer of material (for an etching process). It is well known that, for a variety of reasons, photolithography systems do not print exactly what is depicted in a theoretical target pattern, e.g., the lengths of line-type features may be shorter than anticipated, corners may be rounded instead of square, etc. There are several factors that cause such printing differences, such as interference between light beams transmitted through adjacent patterns, resist processes, the reflection of light from adjacent or underlying materials or structures, unacceptable variations in topography, etc. Such errors will generally be referred to herein as optical proximity errors. One technique used in designing and developing masks for use in semiconductor manufacturing to overcome or at least reduce such optical proximity errors involves the use of software-based optical proximity correction (OPC) techniques in an effort to make sure that a mask, when used, generates the desired pattern on the target material or structure in a reliable and repeatable manner. In recent years, the accuracy of pattern transfer in photolithography processes has become even more important and more difficult due to, among other things, the ongoing shrinkage of various features on integrated circuit devices.

There are several OPC correction methods that have been employed within the industry. These methods are roughly classified into rules-based approaches and simulation-based approaches. Both of these techniques are software-based approaches that are time-consuming and expensive to perform. In general, rules-based approaches involve modifying the mask or reticle to account for errors that are anticipated in the photolithography process. For example, using a rules-based approach may involve making a mask wherein the geometry of a feature on the mask is modified (e.g., a line may be lengthened to account for a reduced length when actually printed), a corner stressing pattern may be placed in corners of the pattern to reduce corner rounding, one or more assist features (that are smaller than the resolution limit of the photolithography) may be formed on a mask, etc. Simulation-based approaches used for OPC involve modeling the exposure processes and attempting to predict, based upon such models, how accurately a target pattern will be formed using a particular photolithography process. Such simulation-based approaches typically require a great deal of processing time and very lengthy calculations.

The photolithographic masks or reticles referred to above comprise geometric patterns corresponding to the circuit components that are part of an integrated circuit product. The patterns used to create such masks or reticles are generated utilizing computer-aided design (CAD) programs, wherein this process is sometimes referred to as electronic design automation. Most CAD programs follow a set of predetermined design rules in order to create functional masks. These rules are set by processing and design limitations. For example, design rules define the space tolerance between circuit devices (such as gates, capacitors, etc.) or interconnect lines, so as to ensure that the circuit devices or lines do not interact with one another in an undesirable way. The design rule limitations are typically referred to as “critical dimensions” (CD). A critical dimension of a circuit can be defined as the smallest width of a line or hole or the smallest space between two lines or two holes. Thus, the CD determines the overall size and density of the designed circuit.

Of course, the ultimate goal in integrated circuit fabrication is to faithfully reproduce the original circuit design on the integrated circuit product. Historically, the feature sizes and pitches (spacing between features) employed in integrated circuit products were such that a desired pattern could be formed using a single patterned photoresist masking layer. However, in recent years, device dimensions and pitches have been reduced to the point where existing photolithography tools, e.g., 193 nm wavelength photolithography tools, cannot form single patterned mask layer with all of the features of the overall target pattern. Accordingly, device designers have resorted to techniques that involve performing multiple exposures to define a single target pattern in a layer of material. One such technique is generally referred to as double patterning. In general, double patterning is an exposure method that involves splitting (i.e., dividing or separating) a dense overall target circuit pattern into two separate, less-dense patterns. The simplified, less-dense patterns are then printed separately on a wafer utilizing two separate masks (where one of the masks is utilized to image one of the less-dense patterns, and the other mask is utilized to image the other less-dense pattern). Further, in some cases, the second pattern is printed in between the lines of the first pattern such that the imaged wafer has, for example, a feature pitch which is half that found on either of the two less-dense masks. This technique effectively lowers the complexity of the photolithography process, improving the achievable resolution and enabling the printing of far smaller features than would otherwise be possible using existing photolithography tools.

While OPC processes are performed on each of the two less-dense masks in such a double patterning process, to date the OPC treatments of the respective masks is often insufficient to obtain acceptable imaging performance. This is due in part to the stronger proximity effects that occur when imaging features having increasingly smaller CDs, such as, for example, in the 20 nm mode, and such problems are only expected to increase as device dimensions continue to be reduced.

The present disclosure is directed to various optical proximity correction (OPC) methods as it relates to the design of masks or reticles to be used in multiple patterning processes and to the use of such masks or reticles in various photolithography systems to manufacture integrated circuit products.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present disclosure is directed to various optical proximity correction methods as it relates to the design of masks or reticles to be used in multiple patterning processes and to the use of such masks or reticles in various photolithography systems to manufacture integrated circuit products. One illustrative method disclosed herein includes the steps of decomposing an initial overall target pattern into at least a first sub-target pattern and a second sub-target pattern, wherein each of the first and second sub-target patterns comprise at least one feature, and performing a first optical proximity correction process on the first sub-target pattern, wherein a position of at least one feature of the second sub-target pattern in the initial overall target pattern is considered when performing the first optical proximity correction process.

In another illustrative example, a method disclosed herein includes the steps of decomposing an initial overall target pattern into at least a first sub-target pattern and a second sub-target pattern, wherein each of the first and second sub-target patterns comprise a plurality of features, performing a first optical proximity correction process on the first sub-target pattern wherein a position of each of the plurality of features of the second sub-target pattern in the initial overall target pattern is considered when performing the first optical proximity correction process, and performing a second optical proximity correction process on the second sub-target pattern, wherein a position of each of the plurality of features of the first sub-target pattern in the initial overall target pattern is considered when performing the second optical proximity correction process.

### BRIEF DESCRIPTION OF THE DRAWINGS

The disclosure may be understood by reference to the following description taken in conjunction with the accompanying drawings, in which like reference numerals identify like elements, and in which:

FIGS. 1A-1C depict one illustrative method disclosed herein of performing optical proximity correction as it relates to the manufacture of masks that will be employed in manufacturing products, such as integrated circuit products;

FIGS. 2A-2G depict another illustrative method disclosed herein of performing optical proximity correction as it relates to the manufacture of masks that will be employed in manufacturing products, such as integrated circuit products;

FIG. 3 depicts one illustrative method disclosed herein in flowchart form; and

FIG. 4 schematically depicts an illustrative system disclosed herein for exposing a plurality of substrates using the reticles designed as disclosed herein.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The present disclosure is directed to various OPC methods as it relates to the design of masks to be used in multiple patterning processes, such as double patterning processes, and to the use of such masks during the manufacture of integrated circuit products. As will be readily apparent to those skilled in the art upon a complete reading of the present application, the methods disclosed herein may be employed in the fabrication of a variety of devices, such as logic devices, memory devices, ASICs, etc., and they may be employed to manufacture semiconductor devices as device dimensions continue to shrink. With reference to the attached figures, various illustrative embodiments of the methods disclosed herein will now be described in more detail.

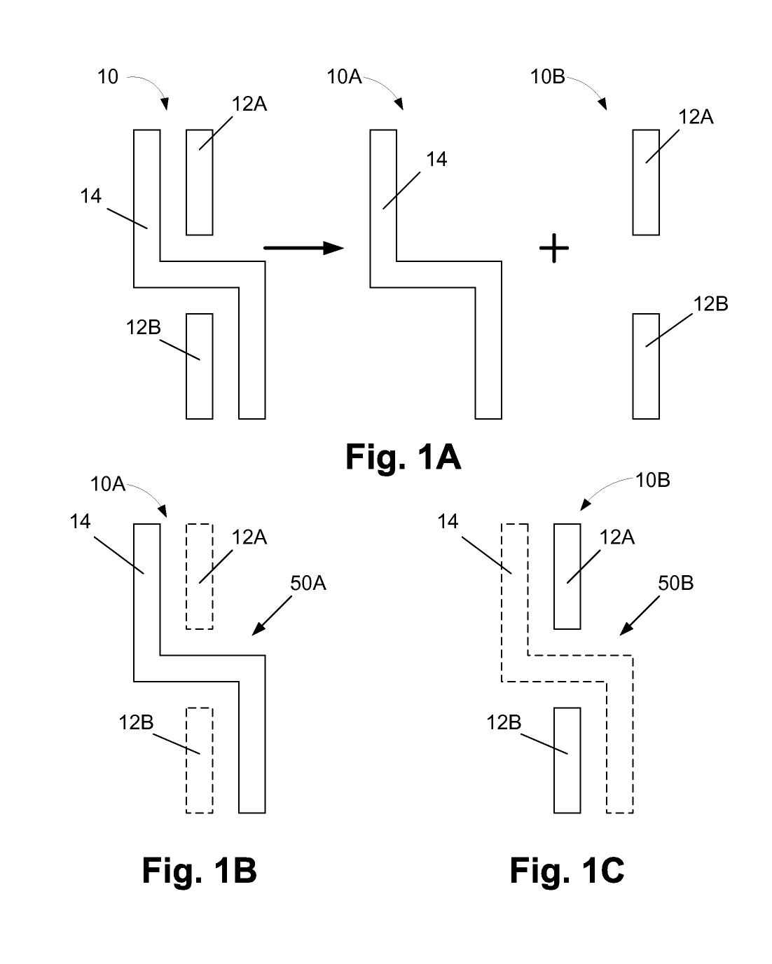

FIGS. 1A-1C depict one illustrative example of a method disclosed herein for performing OPC as it relates to the manufacture of a reticle or a mask (not shown) that will be employed in manufacturing integrated circuit products. An initial overall target pattern 10 comprised of features 12A, 12B and 14 are depicted in FIG. 1A. The space (or pitch) between the features in the initial overall target pattern 10 is such that the initial overall target pattern 10 cannot be printed using a single mask with available photolithography tools. Thus, in this illustrative embodiment, the initial overall target pattern 10 is decomposed into a first sub-target pattern 10A (comprised of the feature 14) and a second sub-target pattern 10B (comprised of the features 12A, 12B). The sub-target patterns 10A, 10B are referred to as “sub-target patterns” because each of them contains less than all of the features in the initial overall target pattern 10. The features that are incorporated in the sub-target patterns 10A, 10B are selected and spaced such that the features may be readily formed using available photolithography tools. Ultimately, when the mask design process is completed, data corresponding to the sub-target patterns 10A, 10B (modified as necessary during the design process) will be provided to a mask manufacturer that will produce a tangible mask (not shown) to be used in a photolithographic tool to manufacture integrated circuit products. In this example, by using well-known double patterning techniques, performing separate etching steps using tangible masks that are made based on the sub-target patterns 10A, 10B, the initial overall target pattern 10 may be formed in or transferred to a layer of material that is part of an integrated circuit product.

FIG. 1B is a graphic depiction of one illustrative embodiment of a method of performing OPC, as reflected by the arrow 50A, on the illustrative sub-target pattern 10A. More specifically, the position of at least one of the features in the second sub-target pattern 10B (comprised of features 12A, 12B) in the initial overall target pattern 10 is considered when OPC is performed on the first sub-target pattern 10A. That is, a reference layer comprised of at least portions of the second sub-target 10B is used in the OPC process performed on the first sub-target pattern 10A. By forcing the OPC process on the first sub-target pattern 10A to consider structures represented by the second sub-target pattern 10B that are intended to be formed in or on the underlying layer of material, the OPC process for the first sub-target pattern 10A becomes more accurate and produces a pattern that is more likely to produce an acceptable version of the initial overall target pattern 10.

The positions of the features 12A, 12B that are in the second sub-target pattern 10B may be input into a computer system that is used in performing the OPC process on the first sub-target pattern 10A using a variety of known techniques. In one example, a mask-rule-constraint (MRC) method may be used to define various constraints between the features in the first sub-target pattern 10A and the features 12A, 12B from the second sub-target pattern 10B. That is, various dimensional constraints may be established between the feature 14 in the first sub-pattern 10A and the features 12A and/or 12B from the second sub-target pattern 10B. Such MRC constraint methodologies are well known to those skilled in the art. In another illustrative example, an inverse of the reference layer, i.e., an inverse of the second sub-target pattern 10B, may be input using a “wafer-enclosed-by” command found in many OPC programs to effectively result in an image for the first exposure that will not bridge with the inverted reference layer. Of course, other methods may be employed to input the desired features from the second sub-target pattern 10B into the OPC process that is performed on the first sub-target pattern 10A, e.g., the features from the second sub-target pattern 10B appear only on the printed image on the wafer and not on the first mask associated with the first sub-target pattern 10A. This discussion about illustrative techniques for inputting information from a second sub-target pattern into an OPC process performed on a first sub-target pattern apply equally to all such similar situations described below.

In FIG. 1B, the features 12A, 12B are depicted in dashed lines to make it clear that the features 12A, 12B are not actually part of the first sub-target pattern 10A, as they are only inputs to the OPC process being performed for the first sub-target pattern 10A. Additionally, it should be understood that it is not required that the location of all of the features present on the second sub-target pattern 10B be used when performing OPC on the first sub-target pattern 10A. For example, if desired, only the location of the feature 12A may be used in performing OPC on the first sub-target pattern 10A. The decision as to which features from the second sub-target pattern 10B to be included or considered when performing OPC on the first sub-target pattern 10A may be a matter of the particular design at issue as well as the capability of tools that will be employed in manufacturing integrated circuit products. The OPC process performed on the first sub-target pattern 10A may indicate that the configuration of the first sub-target pattern 10A needs to be modified in order to produce the desired overall target pattern 10. To the extent such modifications are required, the configuration of the first sub-target pattern 10A may be modified in accordance with standard OPC techniques, e.g., line length may be increased (such a modified pattern is not depicted herein). This OPC process (an iterative process) may be repeated as often as necessary until a final mask shape for the first sub-target pattern 10A is developed that will produce an acceptable transfer of the initial overall target pattern 10. In general, any type of OPC method may be employed with the inventions disclosed herein, e.g., rules-based approaches, simulation-based approaches, or combinations thereof. Thus, the particular type of OPC process performed on the pattern 10A, and the other patterns discussed below, should not be considered to be a limitation of the present invention. The comments in this paragraph apply equally to the other illustrative embodiments described below.

FIG. 1C is a graphic depiction of a method disclosed herein of performing OPC, as reflected by the arrow 50B, on the second sub-target pattern 10B. More specifically, in this example, the position of the feature 14 (in the first sub-target pattern 10A) in the initial overall target pattern 10 is considered when OPC is performed on the second sub-target pattern 10B. In FIG. 1C, the feature 14 is depicted in dashed lines to make it clear that the feature 14 is not actually part of the second sub-target pattern 10B, as it is only an input to the OPC process being performed for the second sub-target pattern 10B.

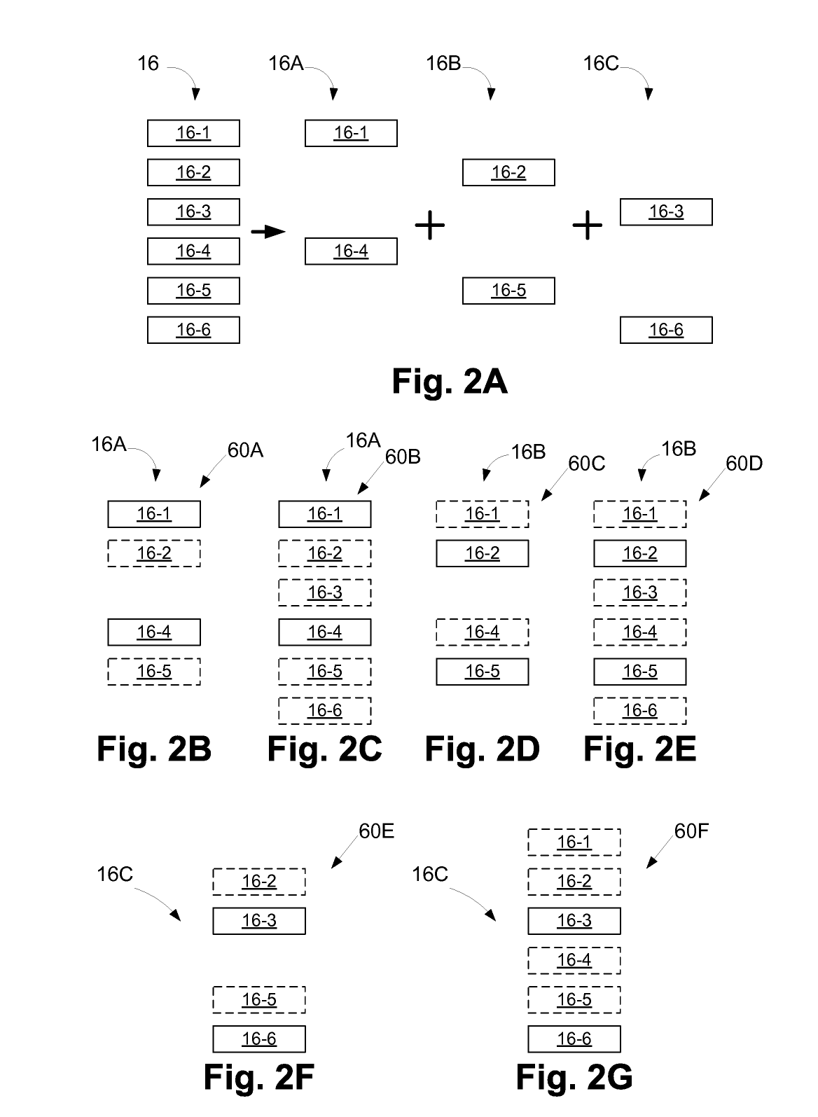

FIGS. 2A-2G depict another illustrative method disclosed herein of performing OPC during the design of tangible masks or reticles. An initial overall target pattern 16 comprised of multiple horizontally-oriented line-type features 16-1 . . . 16-6 is depicted in FIG. 2A. The space (or pitch) between the features in the initial overall target pattern 16 is such that the initial overall target pattern 16 cannot be printed using a single mask with available photolithography tools or double patterning techniques. Thus, in this illustrative embodiment, the initial overall target pattern 16 is decomposed into a first sub-target pattern 16A (comprised of the features 16-1 and 16-4), a second sub-target pattern 16B (comprised of the features 16-2 and 16-5) and a third sub-target pattern 16C (comprised of the features 16-3 and 16-6). The features that are incorporated in the sub-target patterns 16A, 16B and 16C are selected such that the features on each mask are of a size and spacing such that they may be readily formed using available photolithography tools. By using the real-world masks (not shown) that are manufactured based upon the data corresponding to sub-target patterns 16A, 16B and 16C (modified as necessary during the design process), and performing separate etching steps, the initial overall target pattern 16 may be formed in or transferred to a layer of material that is part of an integrated circuit product.

FIG. 2B is a graphic depiction of one illustrative embodiment of a method of performing OPC, as reflected by the arrow 60A, on the illustrative first sub-target pattern 16A. More specifically, the position of the features (16-2 and 16-5) in the second sub-target pattern 16B relative to position of the features (16-1 and 16-4) in the first sub-target pattern 16A in the initial overall target pattern 16 is considered when the OPC process 60A is performed on first sub-target pattern 16A. As before, in FIG. 2B, the features 16-2 and 16-5 are depicted in dashed lines to make it clear that the features 16-2 and 16-5 are not actually part of first sub-target pattern 16A, as they are only inputs to the OPC process 60A being performed for the first sub-target pattern 16A. Note that, in this illustrative example, only the features 16-2 and 16-5 from the second sub-target pattern 16B are used in performing OPC on the first sub-target pattern 16A. In some cases, it may be appropriate to only include the features 16-3 and 16-6 from the third sub-target pattern 16C when performing OPC on the first sub-target pattern 16A. FIG. 2C graphically depicts the situation where an OPC process performed on the first sub-target pattern 16A, as reflected by the arrow 60B, considers the positions of all of the features on both the second sub-target pattern 16B and the third sub-target pattern 16C, i.e., features 16-2, 16-3, 16-5 and 16-6.

FIG. 2D is a graphic depiction of a method disclosed herein of performing an OPC process, as reflected by the arrow 60C, on the illustrative second sub-target pattern 16B. More specifically, the position of the features (16-1 and 16-4) in the first sub-target pattern 16A relative to the position of the features (16-2 and 16-5) in the second sub-target pattern 16B in the initial overall target pattern 16 is considered when the OPC process 60C is performed on the second sub-target pattern 16B. The positions of the features 16-1 and 16-4 in the first sub-target pattern 16A may be input into the computer system performing the OPC process 60C using a variety of known techniques as described above. As before, in FIG. 2D, the features 16-1 and 16-4 are depicted in dashed lines to make it clear that the features 16-1 and 16-4 are not actually part of the sub-target pattern 16B, as they are only inputs to the

OPC process 60C being performed for the second sub-target pattern 16B. FIG. 2E graphically depicts the situation where an OPC process that is performed on the second sub-target pattern 16B, as reflected by the arrow 60D, considers the positions of all of the features on both the first sub-target pattern 16A and the third sub-target pattern 16C, i.e., features 16-1, 16-3, 16-4 and 16-6.

FIG. 2F is a graphic depiction of a method disclosed herein of performing an OPC process, as reflected by the arrow 60E, on the third sub-target pattern 16C. More specifically, in this example, only the position of the features (16-2 and 16-5) in the second sub-target pattern 16B relative to the position of the features (16-3 and 16-6) in the third sub-target pattern 16C in the initial overall target pattern 16 is considered when the OPC process 60E is performed on the third software mask 16C. As before, in FIG. 2F, the features 16-2 and 16-5 are depicted in dashed lines to make it clear that the features 16-2 and 16-5 are not actually part of the third sub-target pattern 16C, as they are only inputs to the OPC process 60E being performed for the third sub-target pattern 16C. FIG. 2G graphically depicts the situation where an OPC process that is performed on the third sub-target pattern 16C, as reflected by the arrow 60F, considers the positions of all of the features on both the first sub-target pattern 16A and the second sub-target pattern 16B, i.e., features 16-1, 16-2, 16-4 and 16-5.

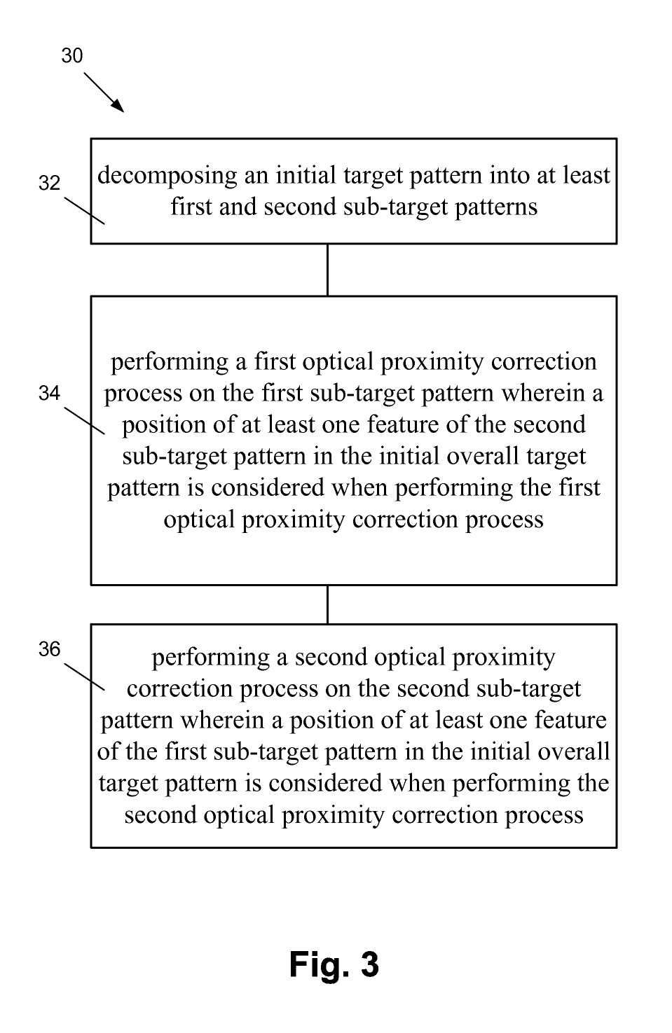

FIG. 3 depicts one illustrative embodiment of a method 30 disclosed herein in flow chart form. As shown therein, in one embodiment, the method comprises decomposing an initial target pattern into at least first and second sub-target patterns, as indicated in box 32, and performing a first optical proximity correction process on the first sub-target pattern, wherein a position of at least one of the features in the second sub-target pattern is considered when performing the first optical proximity correction process, as reflected in box 34. In further embodiments, the method includes the additional step of performing a second optical proximity correction process on the second sub-target pattern, wherein a position of at least one feature in the first sub-target pattern is considered when performing the second optical proximity process, as indicated in box 36. As will be recognized by those skilled in the art after a complete reading of the present application, the inventions disclosed herein may be employed in situations where an original target pattern may be decomposed into multiple sub-target patterns, e.g., three, four, or more sub-target patterns, etc. Thus, the present invention should not be considered as limited to the illustrative double patterning example shown in FIGS. 1A-1C, or the illustrative triple patterning example shown in FIGS. 2A-2G.

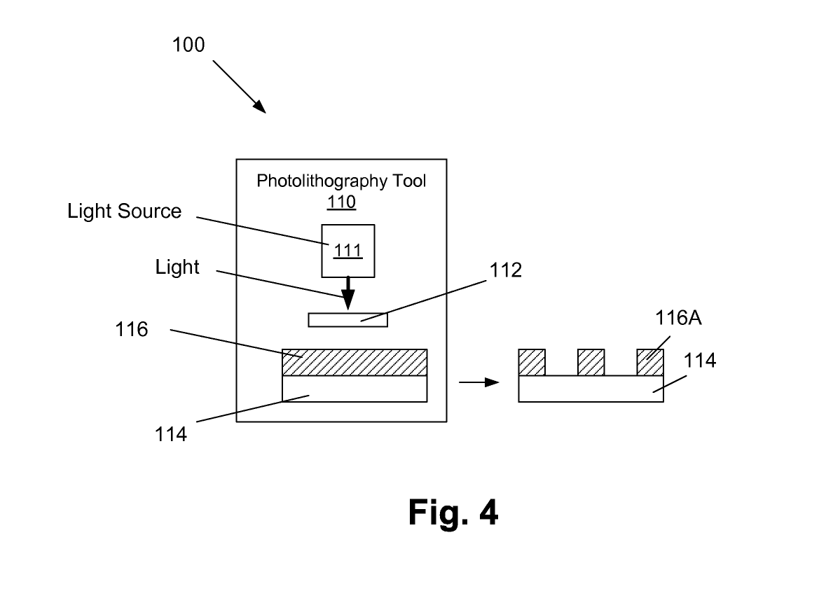

FIG. 4 schematically depicts an illustrative system 100 comprised of a photo-lithography tool 110 (having a light source 111), a reticle 112, an illustrative substrate or wafer 114 and layer of radiation sensitive material, e.g., photoresist 116, formed above the wafer 114. At least portions of the data to be used in manufacturing the reticle 112 may be generated based on the various OPC methods described above. The data may then be provided to a manufacturer to manufacture the reticle 112. The reticle 112 may then be employed in the photolithography tool 110 (which may be of any desired configuration and employ any desired wavelength or form of radiation) by an integrated circuit device manufacturer to expose the layer of photoresist 116 in the photolithography tool 110 such that the pattern in the reticle 112 may be transferred to the layer of photoresist 116. Thereafter the exposed layer of photoresist may then be developed using traditional processes to thereby define a patterned layer of photoresist 116A that may be used in fabricating or defining various portions or regions of an integrated circuit product that will be formed on the substrate 114. The reticle 112 may be used to form patterned layers of photoresist above additional wafers as processing continues.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method of lithography, comprising:
decomposing an initial overall target pattern into at least a first sub-target pattern and a second sub-target pattern, wherein each of said first and second sub-target patterns comprise at least one feature;
inputting a location of said at least one feature in said second sub-target pattern into a computer system that will be used to perform a first optical proximity correction process on said first sub-target pattern; and
performing said first optical proximity correction process on said first sub-target pattern, wherein said input location of said at least one feature of said second sub-target pattern in said initial overall target pattern is considered when performing said first optical proximity correction process.

2. The method of claim 1, further comprising:
inputting a location of said at least one feature in said first sub-target pattern into said computer system that will be used to perform a second optical proximity correction process on said second sub-target pattern; and
performing said second optical proximity correction process on said second sub-target pattern, wherein said input location of said at least one feature of said first sub-target pattern in said initial overall target pattern is considered when performing said second optical proximity correction process.

3. The method of claim 1, wherein a location of all features of said second sub-target pattern in said initial overall target pattern is input into said computer system and considered when performing said first optical proximity correction process.

4. The method of claim 2, wherein a location of all features of said first sub-target pattern in said initial overall target pattern is input into said computer system and considered when performing said second optical proximity correction process.

5. The method of claim 1, further comprising manufacturing a reticle based upon said first sub-target pattern that was subjected to said first optical correction process.

6. The method of claim 5, further comprising positioning said reticle in a photolithography tool and exposing a light sensitive layer of material formed above a substrate to light based upon a pattern defined in said reticle.

7. A method of lithography, comprising:
decomposing an initial overall target pattern into at least a first sub-target pattern and a second sub-target pattern, wherein each of said first and second sub-target patterns comprise a plurality of features;
inputting a location of each of said plurality of features in said second sub-target pattern into a computer system that will be used to perform a first optical proximity correction process on said first sub-target pattern;
performing said first optical proximity correction process on said first sub-target pattern, wherein said input location of each of said plurality of features of said second sub-target pattern in said initial overall target pattern is considered when performing said first optical proximity correction process;
inputting a location of each of said plurality of features in said first sub-target pattern into said computer system that will be used to perform a second optical proximity correction process on said second sub-target pattern; and
performing said second optical proximity correction process on said second sub-target pattern, wherein said input location of each of said plurality of features of said first sub-target pattern in said initial overall target pattern is considered when performing said second optical proximity correction process.

8. The method of claim 7, further comprising manufacturing a reticle based upon said first sub-target pattern that was subjected to said first optical correction process and said second sub-target pattern that was subjected to said second optical correction process.

9. The method of claim 8, further comprising positioning said reticle in a photolithography tool and exposing a light sensitive layer of material formed above a substrate to light based upon a pattern defined in said reticle.

10. A method of lithography, comprising:
decomposing an initial overall target pattern into at least a first sub-target pattern, a second sub-target pattern and a third sub-target pattern, wherein each of said first, second and third sub-target patterns comprise at least one feature;
performing a first optical proximity correction process on said first sub-target pattern, wherein a position of at least one feature of said second sub-target pattern in said initial overall target pattern and a position of at least one feature of said third sub-target pattern in said initial overall target pattern is considered when performing said first optical proximity correction process;
performing a second optical proximity correction process on said second sub-target pattern, wherein a position of at least one feature of said first sub-target pattern in said initial overall target pattern and a position of at least one feature of said third sub-target pattern in said initial overall target pattern is considered when performing said second optical proximity correction process; and
performing a third optical proximity correction process on said third sub-target pattern, wherein a position of at least one feature of said first sub-target pattern in said initial overall target pattern and a position of at least one feature of said second sub-target pattern in said initial overall target pattern is considered when performing said third optical proximity correction process.

11. The method of claim 7, wherein a location of all features of said second sub-target pattern in said initial overall target pattern is input into said computer system and considered when performing said first optical proximity correction process.

12. The method of claim 7, wherein a location of all features of said first sub-target pattern in said initial overall target pattern is input into said computer system and considered when performing said second optical proximity correction process.

13. A method of lithography, comprising:
decomposing an initial overall target pattern into at least a first sub-target pattern, a second sub-target pattern and a third sub-target pattern, wherein each of said first, second and third sub-target patterns comprise at least one feature;
inputting a location of said at least one feature in said second sub-target pattern and a location of said at least one third sub-target pattern into a computer system that will be used to perform a first optical proximity correction process on said first sub-target pattern;
performing said first optical proximity correction process on said first sub-target pattern, wherein said input location of said at least one feature of said second sub-target pattern and said input location of said at least one feature in said third sub-target pattern are considered when performing said first optical proximity correction process;
inputting a location of said at least one feature in said first sub-target pattern and a location of said at least one third sub-target pattern into said computer system that will be used to perform a second optical proximity correction process on said second sub-target pattern;
performing said second optical proximity correction process on said second sub-target pattern, wherein said input location of said at least one feature of said first sub-target pattern and said input location of said at least one feature in said third sub-target pattern are considered when performing said second optical proximity correction process;
inputting a location of said at least one feature in said first sub-target pattern and a location of said at least one second sub-target pattern into said computer system that will be used to perform a third optical proximity correction process on said third sub-target pattern; and
performing said third optical proximity correction process on said third sub-target pattern, wherein said input location of said at least one feature of said first sub-target pattern and said input location of said at least one feature in said second sub-target pattern are considered when performing said third optical proximity correction process.
